(19) United States
(12) Patent Application Publication
(10) Pub. No.: US 2007/0009351 A1
(43) Pub. Date: Jan. 11, 2007

(54) Fan apparatus with adapting device

(75) Inventor: Sung-Chih Hsieh, Taipei City (TW)

Correspondence Address: BIRCH STEWART KOLASCH & BIRCH, PO BOX 747, FALLS CHURCH, VA, 22040-0747, US

(73) Assignee: AMA Precision Inc.

(21) Appl. No.: 11/480,853

(22) Filed: Jul. 6, 2006

(30) Foreign Application Priority Data
Jul. 8, 2005 (TW) 094123182

(51) Int. Cl. F03D 3/04; F01D 1/02

(52) U.S. Cl. 415/186

(57) ABSTRACT

In a fan apparatus, a fan cover has a first coupling side coupled to a first adapting side of an adapting device, and a fan has a second coupling side coupled to a second adapting side of the adapting device.

### BACKGROUND OF THE INVENTION

1. Field of the Invention

The present invention relates to a fan apparatus, and more specifically, to a fan apparatus having an adapting device to couple a fan cover and a heat-dissipating fan, which does not match the fan cover.

2. Description of the Prior Art

Heat-dissipating fans play an important role in heat-dissipation for many kinds of electronic products (e.g. CPUs or display chips). As computer technology advances, a faster processing speed means much more power consumption and also much more heat generation. In general, maintaining a constant operating temperature is very important for chips or other electronic components. For example, if the operating temperature of a chip is too high, internal circuits of the chip may have unpredictable problems such as thermal runaway, causing a system crash or permanent damage to the circuit components (e.g. transistors in the chip).

Please refer to FIG. 1. FIG. 1 is a diagram illustrating the structure of a conventional heat sink 100. The heat sink 100 includes a fan 101, a fan cover 102 and heat-dissipating fins 103. The edge of the fan 101 has a fan fixing part 1011, while the edge of the fan cover 102 has a fan cover fixing part 1021. Therefore, the conventional heat sink 100 uses a screw 104 to fix the fan fixing part 1011 onto the fan cover fixing part 1021. In other words, the conventional heat sink 100 uses a screw 104 to install the fan 101 on the fan cover 102, causing air flows generated from the fan 101 to pass the heat-dissipating fins 103 to achieve the heat-dissipating.

In general, manufacturers always design fan apparatuses that are applicable to a specific chip or CPU. Moreover, as mentioned above, the conventional fan cover 102 uses the screw 104 to connect with the fan 101, thus the design of the fan cover 102 can only match the fan 101 in accordance to form the desired fan apparatus. In other words, even though there are many kinds of heat-dissipating fans complying with different sizes and specifications, however, there is only one fan 101 that matches the specification of the fan cover 102 and can thus be installed on it, lowering the selectivity of using the heat sink 100 and limiting the substitution and extension of the heat sink 100. That is, when a new design is made by replacing the original fan specified for the heat sink 100 with a different fan, the fan cover 102 and the fixing means need to be redesigned to make them match the new fan. Certainly, this will substantially enhance research and development costs and fees for reproducing the manufacturing mold. In addition, the screw 104 is utilized to couple the conventional fan cover 102 and the fan 101. However, the quality of the heat sink 100 might be degraded due to bad coupling of the screw 104, the fan fixing part 1011, and the fan cover fixing part 1021.

### SUMMARY OF THE INVENTION

It is therefore one objective of the claimed invention to provide a fan apparatus having an adapting apparatus to couple a fan cover and a heat-dissipating fan, to solve the above-mentioned problems.

According to one embodiment of the claimed invention, a fan apparatus is disclosed. The fan apparatus comprises: a fan cover, comprising a first coupling surface; a fan, having a second coupling surface; and an adapting device, having a first adapting surface and a second adapting surface. The first adapting surface is directly coupled to the first coupling surface and the second adapting surface is directly coupled to the second coupling surface.

According to another embodiment of the claimed invention, a fan apparatus is disclosed. The fan apparatus comprises: a fan, comprising a fan fixing part, and an adapting device capable of adapting the fan to a fan cover. The adapting device comprises at least one hook to hook the fan fixing part.

According to another embodiment of the claimed invention, a fan apparatus is disclosed. The fan apparatus comprises: a fan, comprising at least one hook, and an adapting device capable of adapting the fan to the fan cover. The adapting device comprises an adapting device fixing part. The hook of the fan cover hooks the adapting device fixing part.

The fan apparatus of the claimed invention is for connecting a fan and a fan cover, which originally do not match (i.e. cannot connect to each other directly), with the help of an adapting device. Moreover, the fan apparatus of the claimed invention is for connecting the fan cover and the adapting device without using any screws, but using a hook to position and fix the fan cover onto the adapting device, thus solving structure and quality problems caused by using screws. The manufacturing cost can therefore be further reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a structure of a conventional heat sink.

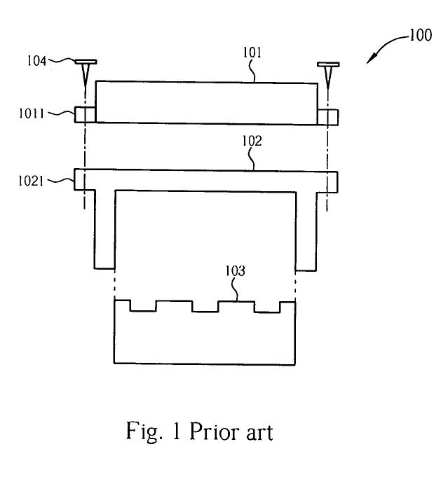

FIG. 2 is a diagram illustrating a structure of a fan apparatus according to a first embodiment of the present invention.

FIG. 3 is a diagram illustrating a structure of a fan apparatus according to a second embodiment of the present invention.

FIG. 4 is a perspective view of a fan used in a fan apparatus of the present invention.

FIG. 5 is a perspective view of a fan apparatus according to a third embodiment of the present invention.

### DETAILED DESCRIPTION

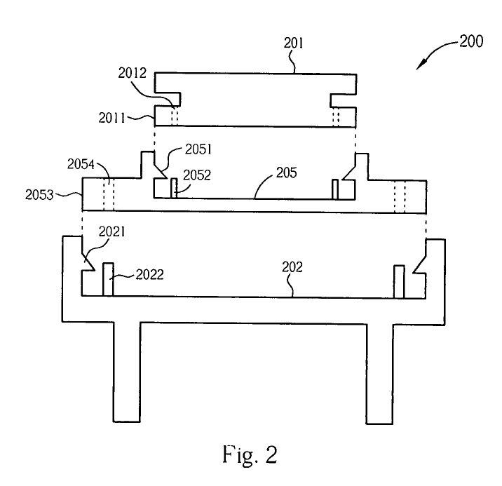

Please refer to FIG. 2. FIG. 2 is a diagram illustrating a structure of a fan apparatus 200 according to a first embodiment of the present invention. The fan apparatus 200 comprises a fan 201, an adapting apparatus 205, and a fan cover 202. In the first embodiment of the present invention, the adapting apparatus 205 comprises a first adapting surface and a second adapting surface, which are used to couple a first coupling surface of the fan cover 202 and a second coupling surface of the fan 201 respectively. The connections among the fan 201, the adapting device 205, and the fan cover 202 are described as follows. An edge of the fan 201 comprises a fan fixing part 2011, and in an embodiment the fan fixing part 2011 comprises a positioning hole 2012. The second adapting surface of the adapting device 205 in an embodiment comprises at least one hook 2051. In another embodiment, the adapting device 205 further comprises at least one positioning pin 2052. Therefore, in an embodiment, when trying to install the fan 201 to the adapting device 205, the hook 2051 of the second adapting surface of the adapting device 205 will lock the fan fixing part 2011 to achieve the objective of fixing the fan 201. Furthermore, in another embodiment, the positioning pin 2052 on the adapting device 205 will pass through the positioning hole 2012 of the fan 201 to achieve the objective of assisting in positioning the fan 201. As shown in FIG. 2, the first coupling surface of the fan cover 202, like the adapting device 205, comprises at least one hook 2021 and at least one positioning pin 2022, and the edge of the adapting device 205 comprises an adapting device fixing part 2053, where the adapting device fixing part 2053 comprises a positioning hole 2054. Therefore, when trying to install the adapting device 205 to the fan cover 202, the hook 2021 of the fan cover 202 will lock the adapting device fixing part 2053 of the adapting device 205 to achieve the objective of fixing the adapting device 205. The positioning pin 2022 of the fan cover 202 will pass through the positioning hole 2054 of the adapting device 205 to achieve the objective of assisting in positioning the adapting device 205. Please note that, in the first embodiment, the positioning pins 2052, 2022 and positioning holes 2012, 2054 provide only a positioning function but no fixing function, therefore they are optional components. That is, the fan apparatus 200 with no positioning pins 2052, 2022 and positioning holes 2012, 2054 also lies in the scope of the present invention.

As shown in FIG. 2, the dimension of the fan 201 is not required to match the dimension of a fan suitable for the fan cover 202. For example, the fan 201 is an 8-inch fan, where the fan cover 202 is designed to install a 12-inch fan, thus, when the fan 201 is not capable of matching the fan cover 202 directly, it can apply the adapting device 205 to connect the fan 201 to the fan cover 202. Therefore, through the assistance of the adapting device 205, the selectivity of the fan can be substantially improved, thus increasing the competitiveness of a fan apparatus on the market. Using an adapting device costs less than redesigning a fan cover to fit a new fan, resulting in better industrial application purposes. On the other hand, unlike prior art fan products that use screws for fixing, the fan cover 200 does not make use of screws for fixing, but uses hooks 2051, 2021 to respectively fix the fan 201 to the adapting device 205 and fix the adapting device 205 to the fan cover 202, thus the fan apparatus 200 provides an improvement to the structure, preventing inconvenience in assembly of the fan apparatus.

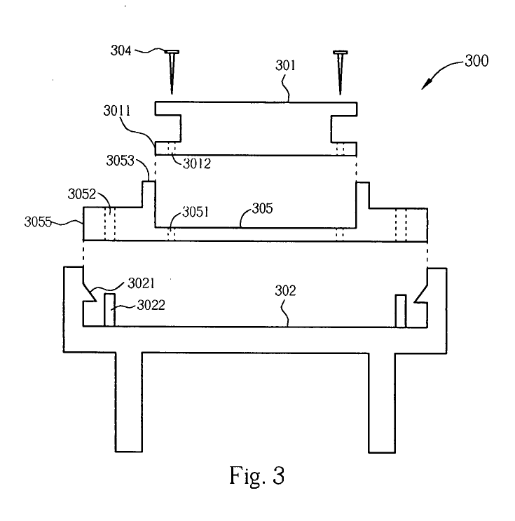

Please refer to FIG. 3. FIG. 3 is a diagram illustrating structure of a fan apparatus 300 according to a second embodiment of the present invention. The fan apparatus 300 comprises a fan 301, an adapting device 305, and a fan cover 302. In the second embodiment, the adapting device 305 comprises a first adapting surface and a second adapting surface, which are used to couple a first coupling surface of the fan cover 302 and a second coupling surface of the fan 301 respectively. The connections among the fan 301, the adapting device 305, and the fan cover 302 are described as follows. In an embodiment, the fan 301 is coupled to the second adapting surface of the adapting device 305 such that a fixing wall 3053 fixes the fan 301. In an embodiment, the fan 301 further comprises at least one positioning hole 3012. Similarly, the second adapting surface of the adapting device 305 comprises at least one positioning hole 3051. Therefore, when trying to install the fan 301 to the adapting device 305, a screw 304 can fix the fan 301 onto the adapting device 305 through the positioning holes 3012 and 3051. As shown in FIG. 3, the first coupling surface of the fan cover 302 comprises at least one hook 3021 and at least one positioning pin 3022, and an edge of the adapting device 305 comprises an adapting device fixing part 3055 having a positioning hole 3052. Therefore, when trying to couple the adapting device 305 to the fan cover 302, the hook 3021 of the fan cover 302 will lock the adapting device fixing part 3055 of the adapting device 305 to achieve an objective of fixing the adapting device 305. On the other hand, the positioning pins 3022 on the fan cover 302 will pass through the positioning hole 3052 of the adapting device 305 to achieve the objective of assisting in positioning the adapting device 305. Please note that in the second embodiment, the positioning pin 3022 and the positioning hole 3052 provide only a positioning function but not a fixing function, thus are optional components. That is, the fan apparatus 300 with no positioning pin 3022 and positioning hole 3051 also lies in the scope of the present invention. In this embodiment, the dimension of the fan 301 is not required to match the dimension of a fan suitable for the fan cover 302. Therefore, when the fan 301 is not capable of being coupled to the fan cover 302 directly, the adapting device 305 is utilized to connect the fan 301 to the fan cover 302. Through the assistance of the adapting device 305, the selectivity of the fan can be substantially improved, thus increasing competitiveness of a fan apparatus on market.

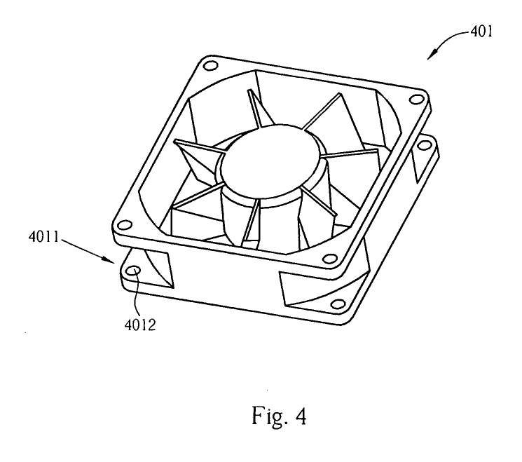

Please refer to FIG. 4. FIG. 4 is a perspective view of a fan used in a fan apparatus of the present invention. A fan 401 comprises a plurality of fan fixing parts. Please note that, for the sake of brevity, only a fan fixing part 4011 is illustrated here. The fan fixing part 4011 comprises a positioning hole 4012. In the first embodiment shown in FIG. 2, the positioning hole 2012 is used to couple the corresponding positioning pin 2052. However, regarding the second embodiment shown in FIG. 3, the positioning hole 3012 of the fan 301 is used to install the screw 304 to fix the fan 301 onto the adapting device 305. In summary, the positioning hole 4012 of the fan fixing part 4011 could act as a positioning component or be used to install a screw according to different structures of the fan apparatus. Please note the structure of the fan 201 or 301 is only for illustrative purposes, and is not meant to be a limitation of the present invention. That is, the fan fixing part 4011 can simultaneously comprise a positioning hole and a screw hole, thus using the positioning hole or the screw hole to fix the fan 401 onto the adapting device 205 or 305 depends on different design requirements, where all of these alternative designs lie in the scope of the present invention.

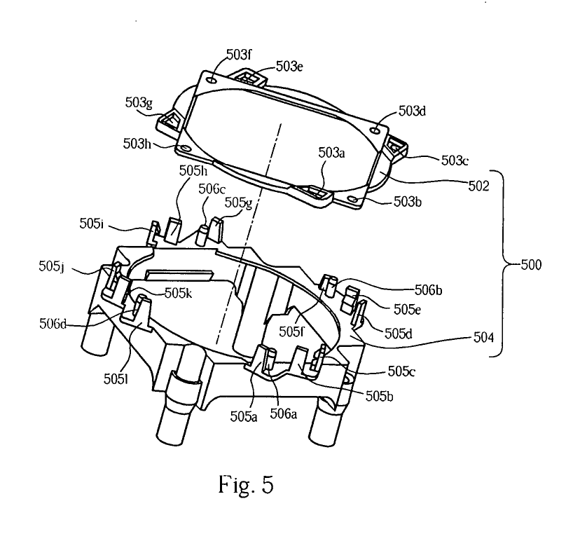

Please refer to FIG. 5. FIG. 5 is a perspective view of a fan apparatus 500 according to a third embodiment of the present invention for describing the connection between an adapting surface and a fan cover. Please note that for purposes of not affecting the disclosure of the present invention, there is no fan shown in FIG. 5. In this embodiment, the fan apparatus 500 comprises an adapting device 502 and a fan cover 504. As shown in FIG. 5, the fan apparatus 500 comprises a plurality of positioning holes 503a-503h, a plurality of positioning pins 506a-506d, and a plurality of hooks 505a-505l. For connecting the adapting device 502 and the fan cover 504, positioning pins 506a-506d of the fan cover 504 will pass through the positioning holes 503a, 503d, 503e, and 503h of the adapting device 502. Moreover, because parts of the adapting device 502 corresponding to the positioning holes 503a, 503c, 503e, and 503g are thicker than positioning holes 503b, 503d, 503f and 503h, the hooks 505a, 505d, 505e, 505g, 505j, and 505k of the fan cover 504 will lock these parts of the adapting device 502 corresponding to the positioning holes 503a, 503c, 503e, and 503g. Therefore, by using the hooks 505a, 505d, 505e, 505g, 505j, and 505k, the adapting device 502 can be fixed on the fan cover 504. On the other hand, with the help of positioning pins 506a-506d, the adapting device 502 is blocked from moving on the surface and is much more solidly installed on the fan cover 504.

Compared with the prior art, the fan apparatus of the present invention does not make use of screws to couple a fan cover and an adapting device, but uses hooks to fix and install the adapting device to the fan cover, thus solving structure and quality problems caused by using screws. The manufacturing cost can therefore be further reduced. Moreover, as shown in FIG. 5, in addition to coupling the fan to the fan cover, the surrounding part of the adapting device can be used to act as an extension of the fan cover after the adapting device is installed on the fan cover. Because of the mismatch between the fan cover and the fan, if the fan is directly installed on the fan cover, there may be some gaps between the fan cover and the fan that will leak air flow, thus degrading the heat dissipating performance. However, the adapting device of the present invention is capable of filling the unwanted gaps. In summary, in the fan apparatus of the claimed invention, a fan cover comprises a first coupling surface, a fan comprises a second coupling surface, and the adapting device comprises a first adapting surface and a second adapting surface, where the first adapting surface is coupled to the first coupling surface and the second adapting surface is coupled to the second coupling surface. Therefore, the claimed invention provides an adapting device to make the fan and fan cover, which originally do not match and cannot be coupled to each other directly, be successfully coupled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fan apparatus comprising:
a fan cover comprising a first coupling surface;
a fan comprising a second coupling surface; and
an adapting device comprising a first adapting surface and a second adapting surface, wherein the first adapting surface is coupled to the first coupling surface and the second adapting surface is coupled to the second coupling surface.

2. The fan apparatus of claim 1, wherein the fan comprises at least a fan fixing part, and the adapting device comprises at least a hook for hooking the fan fixing part.

3. The fan apparatus of claim 2, wherein the fan fixing part comprises at least a positioning hole, and the adapting device further comprises at least a positioning pin to pass through the positioning hole for fixing the fan onto the adapting device.

4. The fan apparatus of claim 1, wherein the fan comprises at least a fan fixing part having at least a first positioning hole, the adapting device further comprises at least a second positioning hole, and the fan apparatus further comprises at least a screw, coupled to the first and the second positioning holes, to fix the fan onto the adapting device.

5. The fan apparatus of claim 1, wherein the adapting device comprises an adapting device fixing part, and the fan cover comprises at least a hook to hook the adapting device fixing part.

6. The fan apparatus of claim 5, wherein the adapting device fixing part comprises at least a positioning hole, and the fan cover further comprises a positioning pin to pass through the positioning hole for fixing the adapting device onto the fan cover.

7. A fan apparatus comprising:
a fan comprising a fan fixing part; and
an adapting device capable of adapting the fan to a fan cover, the adapting device comprising at least a hook for hooking the fan fixing part.

8. The fan apparatus of claim 7, wherein the fan fixing part comprises at least a positioning hole, and the adapting device comprises at least a positioning pin to pass through the positioning hole for positioning the fan on the adapting device.

9. A fan apparatus comprises:
a fan cover comprising at least a hook; and
an adapting device capable of adapting a fan to the fan cover, the adapting device comprising an adapting device fixing part;
wherein the hook of the fan cover hooks the adapting device fixing part.

10. The fan apparatus of claim 9, wherein the adapting device fixing part comprises at least a positioning hole, and the fan cover further comprises at least a positioning pin to pass through the positioning hole for positioning the adapting device on the fan cover.
